(19) United States
(12) Patent Application Publication
(10) Pub. No.: US 2016/0167922 A1
(43) Pub. Date: Jun. 16, 2016

(54) SERVICE LIFT

(71) Applicant: DualLift GmbH, Osterholz-Scharmbeck (DE)

(72) Inventor: Frank Lülfing, Wietze (DE)

(21) Appl. No.: 14/565,923

(22) Filed: Dec. 10, 2014

(51) Int. Cl. B66B 9/02

(52) U.S. Cl. CPC B66B 9/022

(57) ABSTRACT

The invention concerns a service lift, in particular for installation in or on building structures, having a personnel access means, a drive device for upward and downward movement of the personnel access means, and a suspension means which can be fixedly connected to the building and along which the service lift is movable by the drive device. The suspension means has a first and preferably a second drive chain which can be mounted to a fixing point on the building structures, and the drive device has for the or each of the drive chains one or more cogwheels which are in force-transmitting engagement with the respective drive chain to convert a rotation of the cogwheels into the upward or downward movement of the service lift.

### FIELD OF THE INVENTION

The present invention concerns a service lift, in particular for installation in or on building structures, comprising a personnel access means, a drive device for upward and downward movement of the personnel access means, and a suspension means which can be fixedly connected to the building and along which the service lift is movable by the drive device.

### BACKGROUND OF THE INVENTION

Service lifts of the above-indicated kind are used for raising and lowering loads and personnel. In particular service lifts of the above-indicated kind are used when the corresponding building structures already exist and the lifts are retro-fitted therein or have to be temporarily installed there for example during installation works. A typical ample of use is the pylons of wind power installations.

Such lift assemblies and drive mechanisms which are commonly used for same are known for example from DE 10 2010 062 774 A1. In the state of the art steel cables which are secured to a fixed point on the building structure are used as the suspension means. The personnel access means are either moved up and down by means of drum winches which wind on the steel cables, or they are moved up and down by means of so-called endless cable winches, wherein the endless cable winches, by means of a drive pulley, involve a force-coupling connection with the steel cable but do not wind on the cable but in principle move on the freely hanging cable.

Although the movement of service lifts with endless cable winches of the known kind generally functions satisfactorily there is still nonetheless a need for improvement with the known systems. Thus for example due to the action of the drive pulley in the case of known endless cable winches there is a need for the support cables to be replaced because of wear after an operating life of the order of magnitude of 1500 load cycles. In addition even stiff steel cables, by virtue of their structural configuration, have a certain characteristic of being elastic in respect of length, which can lead to oscillations in the vertical direction in operation of the service lifts. The drive mode based on a force-locking connection also gives rise to a certain level of noise.

Therefore the object of the present invention is to provide a service lift which is improved in respect of its drive concept in the above-mentioned points.

### SUMMARY OF THE INVENTION

In the case of a service lift of the kind set forth in the opening part of this specification the object of the invention is attained in that the suspension means has a first and preferably a second drive chain which can be mounted to a fixing point on the building structures, and the drive device for each of the drive chains has one or more cogwheels which are in force-transmitting engagement with the drive chain to convert a rotation of the cogwheels into the upward or downward movement of the service lift.

The invention is based on a complete departure from the known concept of the endless cable winch which requires at least a support cable and a retaining cable, insofar as instead recourse is had to the use of one or two drive chains. The chain-based drive concept offers a number of advantages at the same time: by virtue of the construction of chains which are designed for engagement by cogwheels, the stiffness of the suspension means is markedly improved in comparison with known solutions. There is a less pronounced tendency for oscillations in a vertical direction. A drive chain further has the advantage that in operation it gives rise to markedly less noise which occurs due to engagement of the cogwheels into the drive chain, than an endless cable winch would do with its drive pulley in engagement with a steel cable.

Yet a thither advantage is to be seen in the fact that both the drive chain and also the cogwheels engaging into the drive chain for force transmission can be produced with technically simple means in a tried and tested fashion and as standard components are more readily available than for example drive pulleys of endless cable winches and correspondingly produced steel cables for which a markedly more limited choice of manufacturers is available.

When the service lift is driven by means of cogwheels on the drive chain a lesser degree of wear is also to be expected, by virtue of the positively locking drive concept. The maintenance intervals in the case of a lift installation according to the invention are a multiple longer than with the known systems.

An advantageous development of the invention provides that the drive device has a motor drive with a first drive motor and a second drive motor which are respectively in engagement with one of the two drive chains. Particularly preferably the motor drive comprises the first and second drive motors.

The provision of two drive systems in parallel relationship improves the fail-safety of the service lift. By virtue of the fact that two drive systems with two drive chains are permanently provided in that way it is always possible if required to switch on the second drive if for example the first motor drive is defective. Preferably both systems run at the same time in operation. If one system should fail then the second is at least in a position to securely hold the load. In a preferred development both systems are so designed that they are capable of lifting the load.

In a particular preferred embodiment the drive motors are respectively in the form of gear motors with an electric motor and an electromagnetic brake. The electromagnetic brake provides for reliably arresting the motor for reliably arresting the service lift in its position. In that case for example catch devices as are used in the endless cable winches known in the state of the art are unnecessary. Even for the improbable situation that both drive motors fail at once the electromagnetic brakes provided in both drive motors provide for reliably safeguarding the service lift.

In a further preferred embodiment the drive motors each have a respective centrifugal brake and means for manually unlocking the electromagnetic brake, Theoretically in extreme situations the case can occur where both drive motors are defective and operation cannot be continued after the service lift has stopped. In such a case it is possible with this embodiment for the electromagnetic brakes of the drive motor or motors to be released, whereupon the service lift will begin a downward movement. The speed of downward movement is however restricted to a permissible maximum limit by means of the centrifugal brakes so that it is possible to exclude any safety and injury risks. Preferably the maximum speed of downward movement is in a range of 22 m/min to 28 m/min (particularly preferably 25 m/min).

The centrifugal brake operates even if an electric power supply is no longer guaranteed, which makes the system absolutely fail-safe.

In a particularly preferred development of the invention the drive device is in the form of an endless pass-through chain drive, wherein the length of the drive chains is so dimensioned that in the mounted condition they extend from the suspension means through drive device and laterally along the personnel access means where they hang down. The advantage of drive chains is that they can be provided in principle any length, at a low level of complication and expenditure in terms of manufacturing technology. Thus the same components of the service lift including its drive device can always be used for the most widely varying locations of use and it is only necessary to select the length of the drive chains which are respectively used, so as to be adapted to the location of use, That increases the amount of identical components for the most widely varying locations of use and an increase in cost efficiency is afforded by virtue of scale effects.

In addition the mechanical structure of the drive device is simplified because there is no need to provide means for catching/winding on the drive chains.

In a further preferred configuration of the service lift according to the invention the drive chains are oriented parallel, and are preferably guided. past the personnel access means on the same side of the service lift and are held in a tensioned state in a vertical direction by means of a tensioning weight. In a first preferred alternative the tensioning weight is in the form of a common tensioning weight for both drive chains. In a second alternative the tensioning weight includes two individual weights. The provision of a tensioning weight ensures that the drive chain in the drive device cannot jump relative to the cogwheels, in particular the driving cogwheels, the tensioning weight stabilizing the position and orientation of the drive chains. If a common tensioning weight which holds both drive chains is used for both the chains, at the same time that also permanently ensures parallel orientation of both drive chains.

The drive chains are preferably deflected a plurality of times by the drive device. The deflection serves on the one hand in particular to orient the drive chains substantially perpendicularly with the center of gravity of the personnel access means above the personnel access means so that the personnel access means ‘hangs straight’ and can be better guided for example within building structure shafts. In addition a preferably multiple deflection of the drive chain ensures that the angle with which the chain passes around the force-transmitting cogwheel which is connected to the motor drive is sufficiently great to always hold a sufficient number of teeth in engagement with the chain. That reduces the point loading on individual teeth and wear of the drive system overall is minimized.

Finally the deflection serves to guide the drive chain along the drive device and past the personnel access means.

The additional deflecting, non-driven cogwheels, in addition to the tensioning weight, contribute to ensuring that the chain does not jump and the positively locking connection to the driving cogwheel is always maintained.

In a further preferred embodiment the service lift according to the invention has a lifting force limiting device which is adapted in dependence on a relative movement between the drive device and the personnel access means to stop the upward or downward movement of the service lift, when a predetermined chain load is exceeded. Although the risk of oscillation of the service lift in a vertical direction is already markedly reduced by the use of drive chains in comparison with steel cables, changes in the speed of the service lift, precisely at the beginning or the end of a movement process, involve a time-limited increase in the force acting on the drive chain in a vertical direction (chain load). It has proven to be advantageous for the entire drive device to be designed in the form of a construction which is rigid in itself, and also for the personnel access means to be in the form of a construction which is rigid in itself, but in contrast thereto for the two units to be made movable relative to each other. That affords a system which is mechanically simple to manage, with the option of keeping the number of degrees of freedom down.

Preferably, in that lifting force limiting device, the drive motors are mounted on a common load receiving plate, wherein the load receiving plate is mounted pivotally to the personnel access means and is biased by a spring element in the direction of the personnel access means. Preferably the pivotal movement is inhibited by means of a damper element. The pivot axis, which is the term used to mean the axis about which the load receiving plate pivots relative to the personnel access means, is preferably displaced horizontally relative to a force engagement point of the suspension means, at the suspension means side. Due to that lateral displacement of the pivot axis from the force engagement point at the suspension means side, this provides that the normal force coming from the suspension means at the building structure side, which pulls on the drive chain, has a lever effect (even if slight) about the pivot axis of the load receiving plate. By virtue of that lever, a pivotal movement of the load receiving plate occurs relative to the personnel access means which is again disposed with its mass center of gravity in perpendicular relationship with the chain line at the suspension means side. Alternatively it is preferred that the pivot axis is oriented in coaxial relationship with the transmission shaft. In that way, the pivotal movement of the load receiving plate is preferably triggered solely by the torque of the drives.

Because the spring element is biased in the direction of the personnel access means, the spring counteracts a deflection as a consequence of an increase in normal force of the chain line at the suspension means side. The increase in tensile force as from which a pivotal movement occurs at all can thus be adjusted by way of the level of the biasing effect,

Preferably an interrupt switch for the drive device is arranged on the personnel access means or the load receiving plate in such a way that upon the occurrence of a predetermined deflection of the load receiving plate in opposition to the operative direction of the pre-stressed spring element the switch is triggered. When the interrupt switch is triggered the drive motor is preferably stopped immediately. The damper element preferably provided on the service lift acts between the load receiving plate and the personnel access means to prevent the interrupt switch already being triggered in the event of a jerky start to the travel movement.

In a further preferred embodiment of the service lift it has a device for monitoring tension of the drive chains. In the course of the operating life of each chain an increase in the length of the chain occurs. In extremely rare cases it can further happen that individual chain links fail and suffer from cracking, whereby the chain overall can tear apart if the crack is not discovered in good time.

As optical monitoring of the drive chain seems technically complicated and expensive it is preferred if the tension monitoring device for each drive device has a preferably non-driven cogwheel which is deflectable in non-parallel relationship relative to the respective drive chain and is urged by means of a spring element in the direction of the respective drive chain against same. Preferably an interrupt switch for the drive device is further arranged on the cogwheel, a cogwheel holder which is also moved by the spring element, or the load receiving plate, in such a way that it is triggered when a predetermined deflection of the cogwheels occurs or is exceeded. The cogwheel which is urged in the direction of the drive chain against same by means of the spring element has the effect of displacing the drive chain out of its orientation which is predetermined as a consequence of the chain tension. The chain tension works thereagainst.

The interrupt switch preferably operates on the basis of the same functional. principle as the interrupt switch for the drive device which is provided in the lifting force limiting device. When a predetermined deflection of the cogwheel or the cogwheel holder supporting the cogwheel is attained or exceeded the supply of power to the motor drive is interrupted. Both motors are switched off.

It is particularly preferred in the case of the service lift according to the invention if the two drive motors and the cogs in engagement with the drive chains for both drive chains are of an identical configuration and if moreover both drive chains are also identical. That provides a completely redundant drive system which in the case of a defect in the first drive train ensures that, if the first drive train fails, the other drive train holds the load.

### BRIEF DESCRIPTION OF THE DRAWINGS

The organization and manner of the structure and operation of the invention, together with further objects and advantages thereof, may best be understood by reference to the following description, taken in connection with the accompanying drawings, wherein like reference numerals identify like elements in which:

FIGS. 1a and 1b show different side views of a service lift according to a preferred embodiment;

FIGS. 2a and 2b show various perspective detail views of the service lift of FIGS. 1a and 1b;

FIG. 3 shows a detail side view of the service lift of FIGS. 1 and 2;

FIG. 4 shows a further detail side view of the service lift of FIGS. 1 to 3; and

FIG. 5 shows still a further detail side view of the service lift of FIGS. 1 to 4.

### DETAILED DESCRIPTION OF THE ILLUSTRATED EMBODIMENT

While the invention may be susceptible to embodiment in different forms, there is shown in the drawings, and herein will be described in detail, a specific embodiment with the understanding that the present disclosure is to be considered an exemplification of the principles of the invention, and is not intended to limit the invention to that as illustrated and described herein.

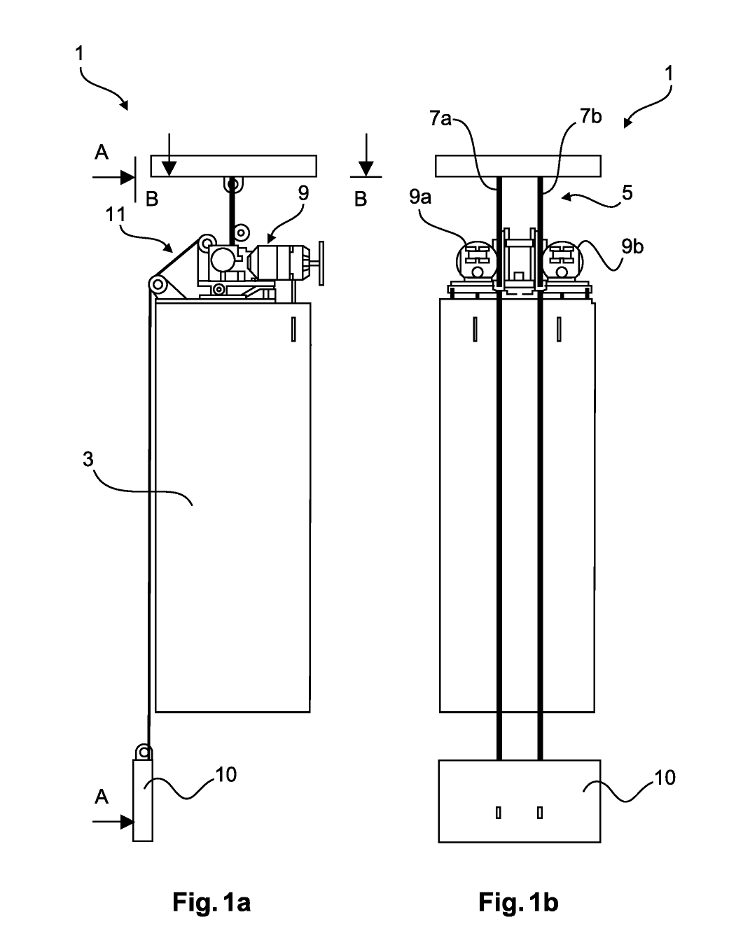

FIGS. 1a and 1b show various side views of a service lift. The service lift 1 has a personnel access means 3. In the present embodiment the personnel access means 3 is in the form of a cabin. Alternative configurations however can also provide for example that the personnel access means is in the form of a basket or cage or a platform.

The personnel access means 3 is mounted to a suspension means 5 which can be fixed to the building. The suspension means 5 includes a first drive chain 7a. and a second drive chain 7b. A transmission device 11 is in engagement with the drive chains 7a, 7b, The transmission device 11 includes a motor drive 9. The motor drive 9 in turn includes a first electric motor 9a and a second electric motor 9b. A tensioning weight 10 holds the drive chains 7a, 7b parallel to each other and in as tensioned condition.

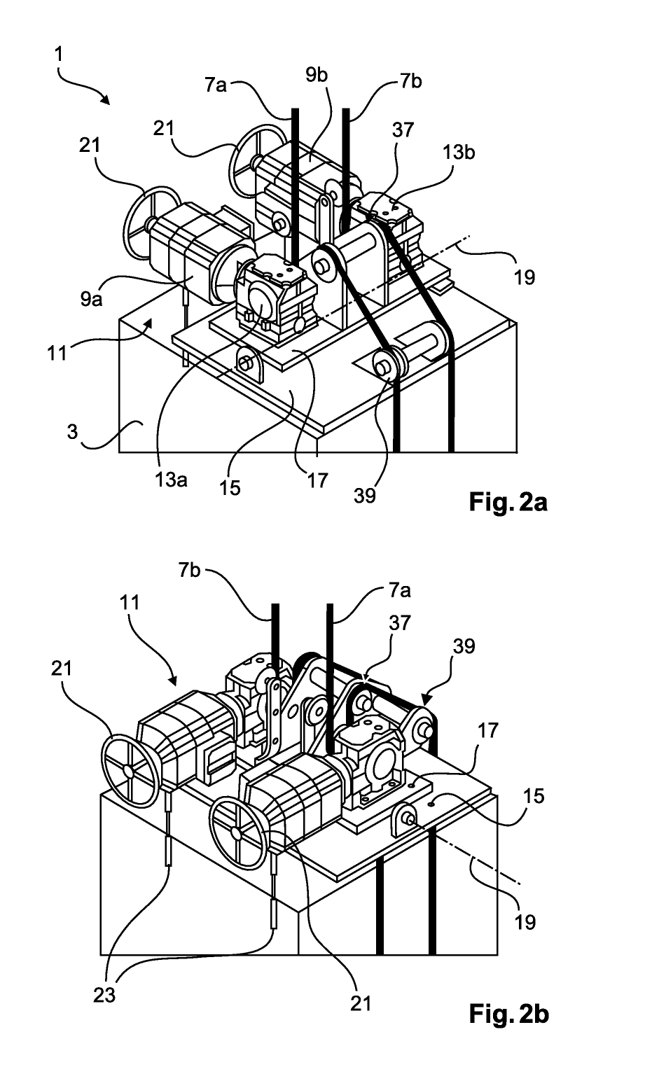

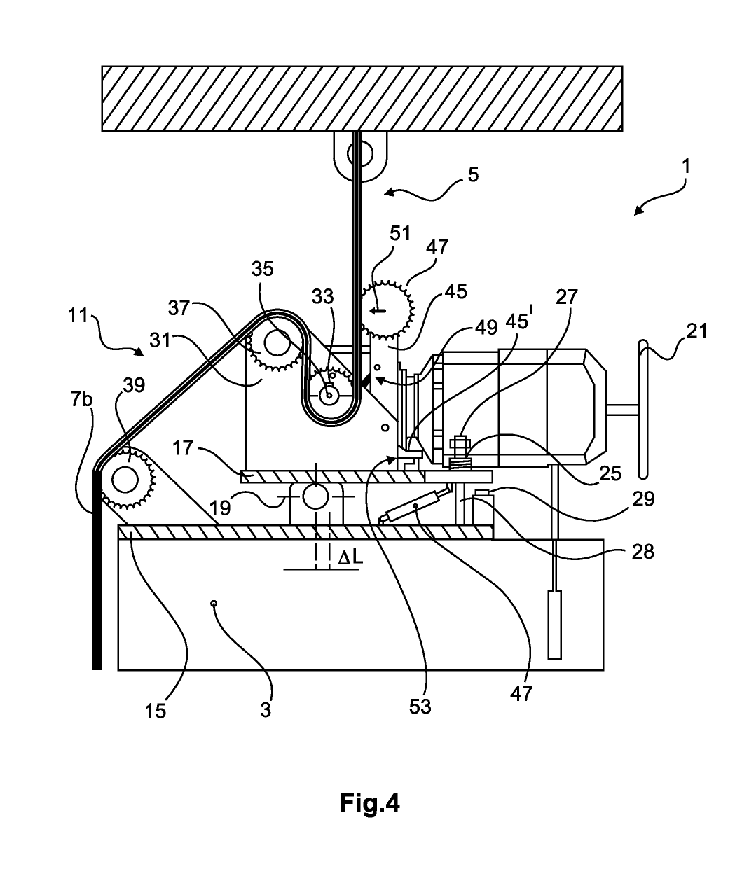

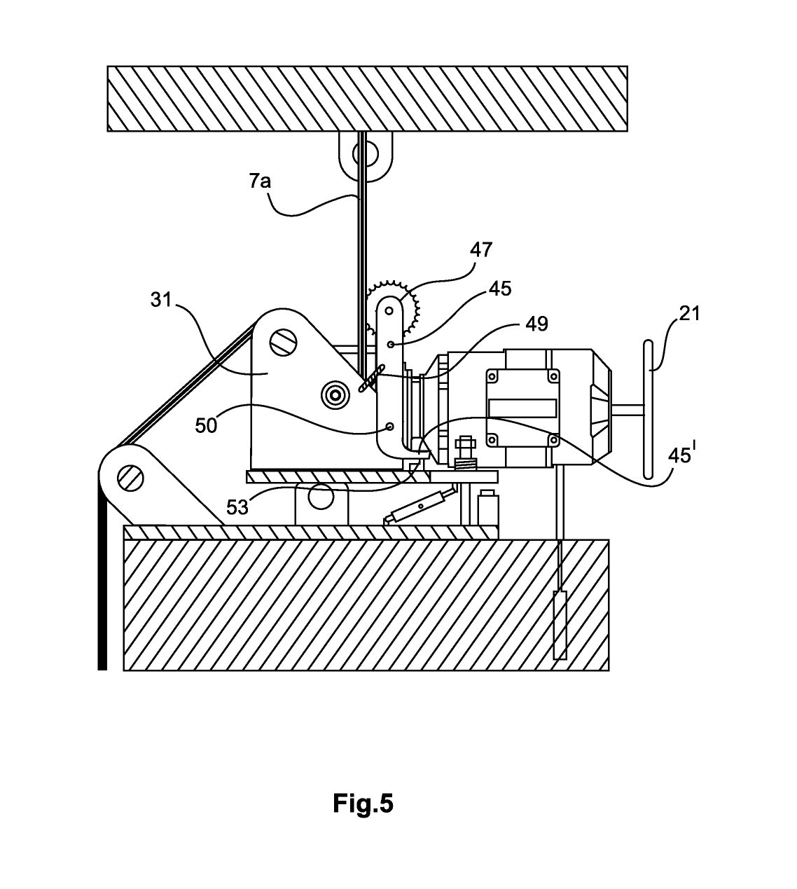

Further details relating to the drive device 11 can be seen from FIGS. 2a and 2b. The electric motor 9a, 9b is respectively coupled to a transmission 13a, 13b. At the drive output side the transmission 13a, 13b is respectively in positively locking engagement by means of a cogwheel (FIGS. 4 and 5) with a respective drive chain 7a, 7b. The electric motors 9a, 9b respectively form a gear motor, together with the transmission 13a, 13b associated with them. The drive device 11 is mounted on the roof of the personnel access means 3. In particular the drive device 11 is arranged on a mounting plate 15 connected fixedly to the personnel access means 3, by being fixed on a load receiving plate 17 which in turn is coupled to the personnel access means 3 pivotally about the axis 19, The electric motors 9a, 9b each have a hand wheel 21. The hand wheel serves for manual adjustment of the chain pre-stressing when assembling the installation. In that way an individual gear motor can be manually moved until both chains are equally pre-stressed. In addition it is possible therewith for a rocker member which is optionally provided at the suspension means side and which connects the chains to the building structure to be brought into balance.

Furthermore the electric motors 9a, 9b are each equipped with a hand lever 23. The hand levers 23 represent a means for manually unlocking an electromagnetic brake provided in the gear motors. In an emergency situation, for example in the event of a power failure, both brakes have to be opened. Then the personnel access means travels downwardly solely due to the force of gravity and the people can be evacuated therefrom.

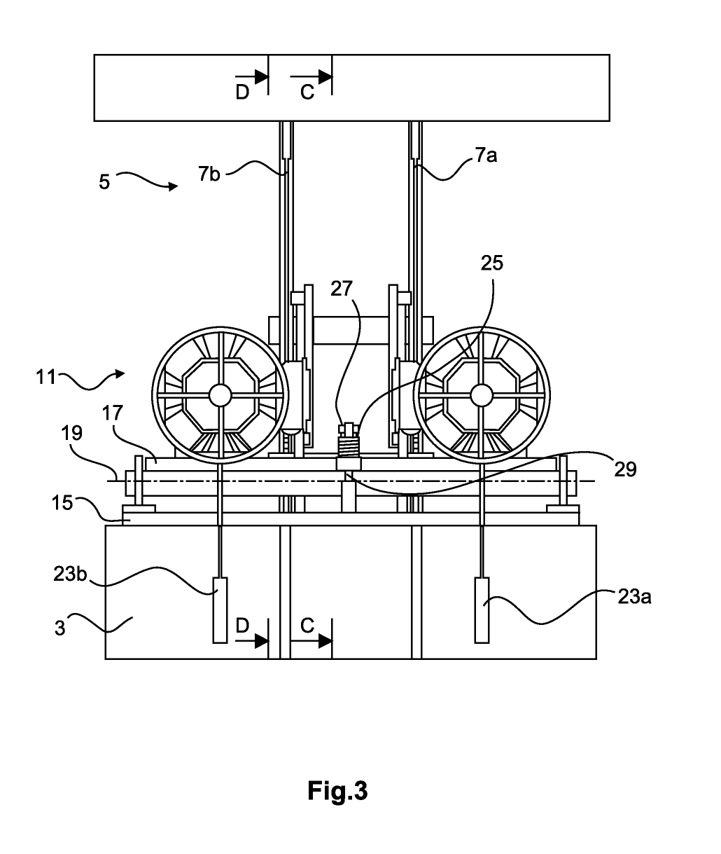

This is shown in greater detail once again in FIG. 3. It can further be seen from FIG. 3 that the drive device 11 further has a spring element 25 which in the present embodiment is in the form of a compression spring and is arranged above the load receiving plate 17. The spring element 25 is adjustable in respect of its biasing force by means of an adjusting screw 27. The spring element 25 urges the portion of the load receiving plate 17, against which it bears, towards the personnel access means 3 in the load direction of the drive chains 7a, 7b. In that situation, as a consequence of the spring pressure, the load receiving plate 17 contacts an interrupt switch 29 arranged between the load receiving plate 17 and the mounting plate 15 or the personnel access means 3.

It will further be seen from FIG. 4 that the pivot axis 19 of the load receiving plate 17 is displaced relative to a force engagement point 33 of the suspension means with the drive device 11 in a horizontal direction by the distance ΔL. As a result, when there is a force acting in the direction of the drive chains 7a, 7b, in the direction of the suspension means 5, there is a torque which would pivot the drive device 11 in the anti-clockwise direction, in the orientation shown in FIG. 4. The spring element 25 acts in opposite relationship thereto. When load peaks occur in the vertical direction the load receiving plate 17 is pivoted against the action of the spring element 25 and is consequently moved away from the interrupt switch 29. When a predetermined deflection of the load receiving plate 17 is reached or exceeded the power supply to the electric motors 9a, 9b is interrupted and operation of the service lift is stopped. That occurs to protect the drive chains 7a, 7b and accordingly the passengers in the personnel access means 3.

As can also be seen from FIG. 4 the load receiving plate 17 is also connected to the mounting plate 15 of the personnel access means 3 by means of a damper element 41. That prevents the lifting force limiting device being triggered when starting off and when slowing down under actual normal conditions for the service lift.

It will also be seen from FIG. 4 that the spring element 25 and the adjusting screw 27 are arranged on a holding bar 28 and are thereby connected to the mounting plate 15 of the personnel access means 3.

FIG. 4 further shows the arrangement of a plurality of cogwheels of the drive device 11. Thus the drive device 11 has a drive cogwheel 33 which is coupled to the transmission of the motor drive 9 (FIG. 1) and which has the drive chain 7b (FIG. 4) passing therearound (and also the drive chain 7a in the other case). The cogwheel 33 is fixed to the transmission shaft 35.

To guarantee the angle through which the chain passes around the drive cogwheel 33 the arrangement has a further non-driven cogwheel 37 which deflects the drive chain 7b. A third cogwheel 39 which is also not driven deflects the drive chain 7b again so that it can hang substantially vertically down at the side of the personnel access means 3.

A further aspect shown in FIG. 4 concerns a device for monitoring the tension of the drive chain. That device has a cogwheel holder 45 which includes a laterally protruding projection 45′. In the condition shown in FIG. 4 the projection 45 on the holder 45 is in contact with an interrupt switch 53 arranged between the load receiving plate 17 and the holder 45. A spring element 49 provides that a cogwheel 47 mounted to the holder 45 is urged in the direction of the arrow 51 against the drive chain 7b. When a predetermined deflection in the direction of the arrow 51 is reached or exceeded the holder is pivoted to such an extent that the interrupt switch 53 is triggered and interrupts the power supply to the motor drive 9 (FIG. 1).

Insofar as, in relation to FIGS. 4 and 5, reference is moreover only ever made to the drive chain 7b and the cogwheels associated therewith and other elements, it is appreciated in that respect that the same description also correspondingly applies to the other drive chain 7a and the elements associated therewith, since, as can be seen from FIGS. 1 to 3, the arrangement of the drive chains, the gear motors and all other components involves mirror symmetry.

FIG. 5 shows a view on to the other side of one of the two supports 31 which mount the cogwheels 33, 35 and the holder 45, The arrangement of the cogwheel 47 for tension monitoring, the holder 45 supporting the cogwheel 47 with its projection 45′ and the spring 49 deflecting the holder 45 are shown here from the front side, as a difference in relation to FIG. 4. The holder 45 is carried by means of a mounting 50 in the support 31.

While preferred embodiments of the present invention are shown and described, it is envisioned that those skilled in the art may devise various modifications of the present invention without departing from the spirit and scope of the invention.

What is claimed:

1. A service lift, in particular for installation in or on building structures, comprising:
a personnel access means;
a drive device for upward and downward movement of the personnel access means, the drive device being fixed on the roof of the personnel access means by means of a mounting plate, the drive device having a motor drive having a first drive motor and a second drive motor, the first drive motor and the second drive motor being of an identical configuration, the drive device having a plurality of cogwheels, each of the cogwheels being of an identical configuration; and
a suspension means which can be fixedly connected to the building structures and along which the service lift is movable by the drive device, wherein the suspension means has a first drive chain and a second drive chain, each of which can be mounted to a fixing point on the building structures, the first drive chain and the second drive chain being of an identical configuration,
wherein one or more cogwheels of the drive device are in force-transmitting engagement with each of the first and second drive chains to convert a rotation of the cogwheels into the upward or downward movement of the service lift.

2. A service lift as defined in claim 1, wherein the first and second drive motors are respectively in the form of gear motors with an electric motor and an electromagnetic brake.

3. A service lift as defined in claim 2, wherein the first and second drive motors each have a respective centrifugal brake and means for manually unlocking the electromagnetic brake.

4. A service lift as defined in claim 1, wherein the drive device is in the form of an endless chain drive, wherein the length of the first and second drive chains is so dimensioned that in the mounted condition they extend from the suspension means through the drive device and laterally along the personnel access means where they hang down.

5. A service lift as defined in claim 1, wherein the first and second drive chains are oriented parallel, and are preferably guided past the personnel access means on the same side of the service lift and are held in a tensioned state in a vertical direction by means of a tensioning weight.

6. A service lift as defined in claim 5, wherein the tensioning weight is in the form of a common tensioning weight for both the first and second drive chains.

7. A service lift as defined in claim 5, wherein each of the first and second drive chains has an individual tensioning weight.

8. A service lift as defined in claim 1, wherein the first and second drive chains are deflected a plurality of times by the drive device.

9. A service lift as defined in claim 1, further comprising a lifting force limiting device which is adapted in dependence on a relative movement between the drive device and the personnel access means to stop the upward or downward movement of the service lift when a predetermined chain load is exceeded.

10. A service lift as defined in claim 9, wherein the first and second drive motors are mounted on a common load receiving plate.

11. A service lift as defined in claim 10, wherein the common load receiving plate is mounted pivotally to the personnel access means about a pivot axis and is biased by a spring element in the direction of the personnel access means.

12. A service lift as defined in claim 11, wherein pivotal movement of the common load receiving plate relative to the personal access means is inhibited by means of a damper element.

13. A service lift as defined in claim 11, wherein the pivot axis is displaced horizontally relative to a chain line of the first and second drive chains at a side of the suspension means.

14. A service lift as defined in claim 11, further comprising an interrupt switch for the drive device which is arranged on one of the personnel access means or the common load receiving plate in such a way that upon the occurrence of a predetermined deflection of the common load receiving plate in opposition to the operative direction of the pre-stressed spring element, the interrupt switch is triggered.

15. A service lift as defined in 1, further comprising a tension monitoring device which monitors the tension of the first and second drive chains.

16. A service lift as defined in claim 15, wherein the tension monitoring device has, for each of the first and second drive motors, a non-driven cogwheel which is deflectable in non-parallel relationship relative to the respective drive chain.

17. A service lift as defined in claim 16, further comprising an interrupt switch for the drive device which is arranged on the non-driven cogwheel.

18. A service lift as defined in claim 15, wherein the tension monitoring device is urged by means of a spring element the direction of the respective drive chain.

19. A service lift as defined in claim 18, further comprising a cogwheel holder which is moved by the spring element in such a way that it is triggered when a predetermined deflection of the non-driven cogwheel occurs or is exceeded.

20. A service lift as defined in claim 18, wherein the first and second drive motors are mounted on a common load receiving plate and further comprising a cogwheel holder which is moved by the common load receiving plate in such a way that it is triggered when a predetermined deflection of the non-driven cogwheel occurs or is exceeded.

21. A service lift as defined in claim 1, wherein the drive device for each drive chain has respective means for manually altering the chain tension.
